(19) United States
(12) Patent Application Publication
(10) Pub. No.: US 2013/0272546 A1
(43) Pub. Date: Oct. 17, 2013

(54) METHODS AND APPARATUS FOR HEAD-WEARABLE PERSONAL SOUND SPEAKER SYSTEMS

(71) Applicant: Christopher Michael Besgen, SR., Ridgefield, CT (US)

(72) Inventor: Christopher Michael Besgen, SR., Ridgefield, CT (US)

(21) Appl. No.: 13/794,782

(22) Filed: Mar. 11, 2013

Related U.S. Application Data
(60) Provisional application No. 61/609,291, filed on Mar. 10, 2012.

(51) Int. Cl. H04R 1/02

(52) U.S. Cl. CPC H04R 1/025
USPC 381/120

(57) ABSTRACT

The invention provided a visor including a headband including an adjustable strap; a bill attached to the headband and including an flexible fabric sound speaker integrally formed within the bill; an amplifier including a signal input, the amplifier removeably attached to the headband and coupled to the speaker; and a power supply removeably attached to the headband and coupled to the amplifier. Numerous additional features are disclosed.

### CROSS-REFERENCE TO RELATED APPLICATION

The present application claims priority to U.S. Provisional Patent Application No. 61/609,291 filed Mar. 10, 2012, entitled “METHODS AND APPARATUS FOR HEAD-WEARABLE PERSONAL SOUND SPEAKER SYSTEMS” the entirety of which is hereby incorporated herein by reference for all purposes.

### FIELD OF THE INVENTION

The present invention generally relates to personal sound speaker systems, and more particularly is directed to methods and apparatus for head-wearable personal sound speaker systems.

### BACKGROUND OF THE INVENTION

With the proliferation of cell phones and portable music devices, many personal portable sound speaker systems (e.g., headphones, earphones, etc.) have been developed that allow the user to participate in relatively vigorous activities (e.g., sports) while listening to their devices and largely block out other environment noises. In some environments however, personal sound systems that exclude or otherwise prevent a user from clearly hearing surrounding sounds can be undesirable. For example, while riding a bicycle or jogging on a street, there may be safety issues with not being able to hear traffic. In fact, many organized road race events do not permit competitors to wear any kind of device that covers the competitor's ears. Thus, what is needed is a personal sound system that allows users to enjoy music or communicate on a cell phone while not blocking out other environment sounds.

### SUMMARY OF THE INVENTION

Inventive methods and apparatus are provided for a visor or cap including a headband including an adjustable strap; a bill attached to the headband and including an flexible fabric sound speaker integrally formed within the bill; an amplifier including a signal input, the amplifier removeably attached to the headband and coupled to the speaker; and a power supply removeably attached to the headband and coupled to the amplifier.

Numerous other aspects are provided. Other features and aspects of the present invention will become more fully apparent from the following detailed description, the appended claims and the accompanying drawings.

### BRIEF DESCRIPTION OF THE DRAWINGS

FIG. 1 is a diagram depicting a side view of an example head-wearable personal sound speaker system according to embodiments of the present invention.

FIG. 2 is a diagram depicting a top perspective view of an example head-wearable personal sound speaker system according to embodiments of the present invention.

FIG. 3 is a diagram depicting a bottom perspective view of an example head-wearable personal sound speaker system according to embodiments of the present invention.

FIG. 4 is a diagram depicting a side view of an example head-wearable personal sound speaker system being worn according to embodiments of the present invention.

FIG. 5 is a diagram depicting a side view of an example head-wearable personal sound speaker system with an extended width bill being worn according to embodiments of the present invention.

FIG. 6 is a diagram depicting a bottom perspective view of an example head-wearable personal sound speaker system according to embodiments of the present invention.

FIG. 7 is a diagram depicting a head-wearable personal sound speaker system kit attachable to a hat or visor according to embodiments of the present invention.

FIG. 8 is a diagram depicting an exploded view of a head-wearable personal sound speaker system kit according to embodiments of the present invention.

FIG. 9 is a diagram depicting a side perspective view of an example head-wearable personal sound speaker system according to embodiments of the present invention.

FIG. 10 is a diagram depicting a head-wearable personal sound speaker system kit attachable to a hat or visor according to embodiments of the present invention.

FIG. 11 is a diagram depicting an exploded view of a head-wearable personal sound speaker system kit according to embodiments of the present invention.

### DETAILED DESCRIPTION

The present invention provides methods and apparatus for a head-wearable personal sound speaker system. In some embodiments, a visor or baseball style cap that includes a bill or sun shade that extends from the front of the visor includes one or more integrally formed flexible speaker elements within the bill. In other words, the speaker elements may be used to form the bill or part thereof. The speaker elements are disposed to direct sound that emanates from the speaker elements at the ears of the user. In some embodiments, the speaker elements may be embodied as low-power (e.g., <0.1 W), thin (e.g., <0.2 inches), light weight (e.g., <0.1 g/cm²) flexible speakers, for example such as those manufactured by Verisonix Corporation of Taipei, Taiwan or the model TLF type speakers manufactured by Yamaha Corporation of

Tokyo, Japan. In some embodiments, the speaker elements maybe directional speakers that emit sound in parallel, directed waves such that the sound is limited to the line in which it is aimed. In some embodiments, small conventional speakers may be used.

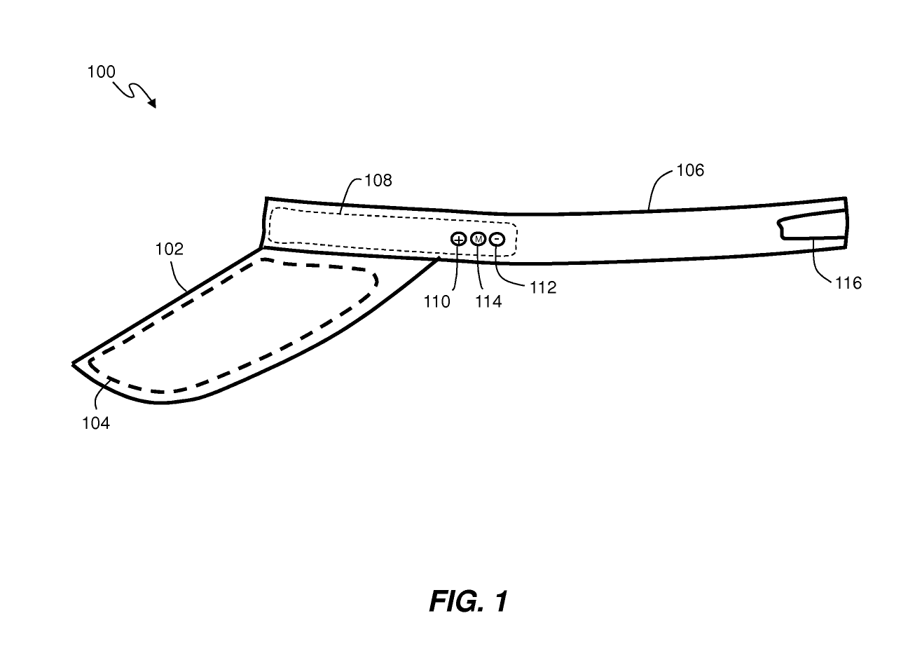

Turning to FIG. 1, a side view of an example head-wearable personal sound speaker system 100 is shown. In the example embodiments shown, the head-wearable personal sound speaker system 100 includes a bill 102 with one or more integrally formed speaker elements 104. The bill 102 may be supported by a headband 106 that includes a sound source assembly 108. The headband 106 may be constructed of a light-weight, breathable fabric that is washable. In some embodiments, the headband 106 may include a removable, washable liner (not shown). The sound source assembly 108 may include one or more control mechanisms such as an up/forward/next button 110, a down/back/previous button 112, and/or a power/mode button 114. The control mechanisms 110, 112, 114 may be adapted to be operable to allow the user to control the sound source assembly 108. In some embodiments, the control mechanisms 110, 112, 114 may be covered by a flap (not shown) or disposed within the fabric of the band 106. In some embodiments, the headband 106 may include an elastic element and/or may include an adjustable fastening device 116 such as a hook and loop mating material, a clip, or buckle.

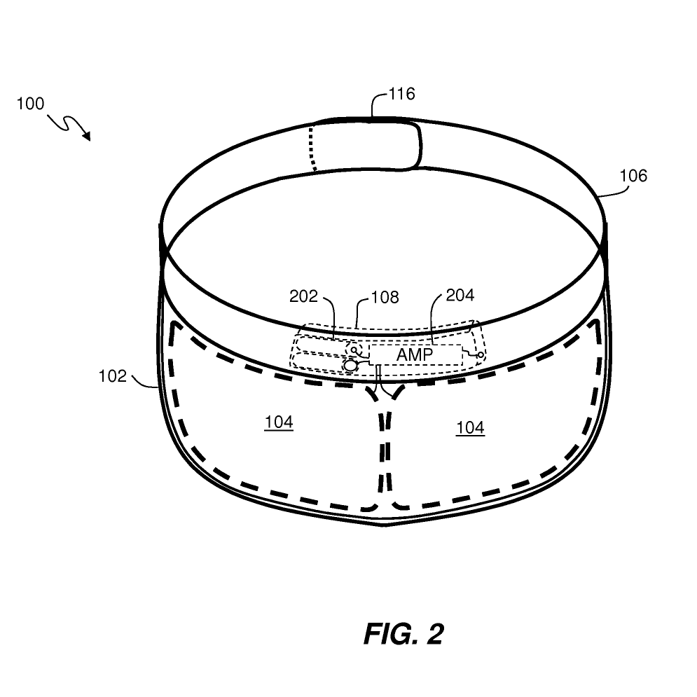

Turning to FIG. 2, a top perspective view of the example head-wearable personal sound speaker system 100 is shown. In this view, the control mechanisms 110, 112, 114 are not represented but additional elements of the sound source assembly 108 are depicted with hidden lines. As shown in FIG. 2, the sound source assembly 108 may include a power source 202 (e.g., batteries) and a sound processing circuitry 204 (e.g., an amplifier, wiring, transmitter, receiver, audio input, etc.) In some embodiments, the sound source assembly 108 may extend across the front of the headband 106 to the sides of the headband 106. In other embodiments, the sound source assembly 108 may be disposed only in the front of the headband 106 with a connection (e.g., one or more wires) extending to the control mechanisms 110, 112, 114 on the side of the headband 106.

As shown in FIG. 2, the head-wearable personal sound speaker system 100 may include two separate speaker elements 104. The separate speaker elements 104 may be coupled to the sound source assembly 108 and adapted to play two channels (e.g., left and right) of stereo sound from the sound source assembly 108. In some embodiments, the bill 102 may also include one or more microphones (not shown) also coupled to the sound source assembly 108 and adapted to allow the system 100 to receive audio (e.g., stereo) input.

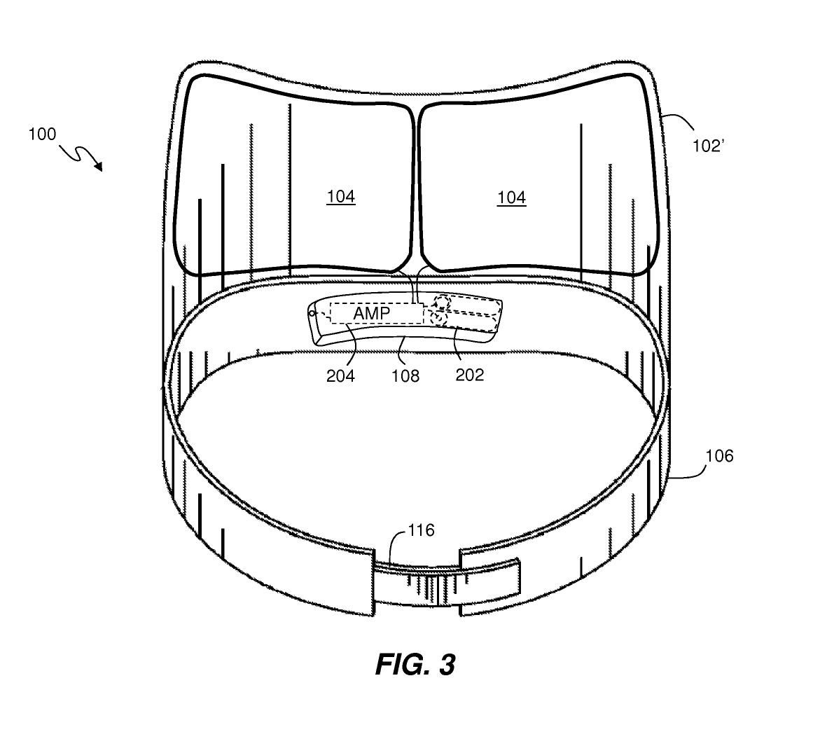

Turning now to FIG. 3, a bottom perspective view of an example embodiment of a head-wearable personal sound speaker system 100 with an alternate bill 102′ is shown. The alternate bill 102′ has an alternate shape that maybe better suited for forming the integral speaker elements 104. Note that in some embodiments the speaker elements 104 may have any shape that is practicable for the uses described herein and in particular for creating direct sound as discussed below.

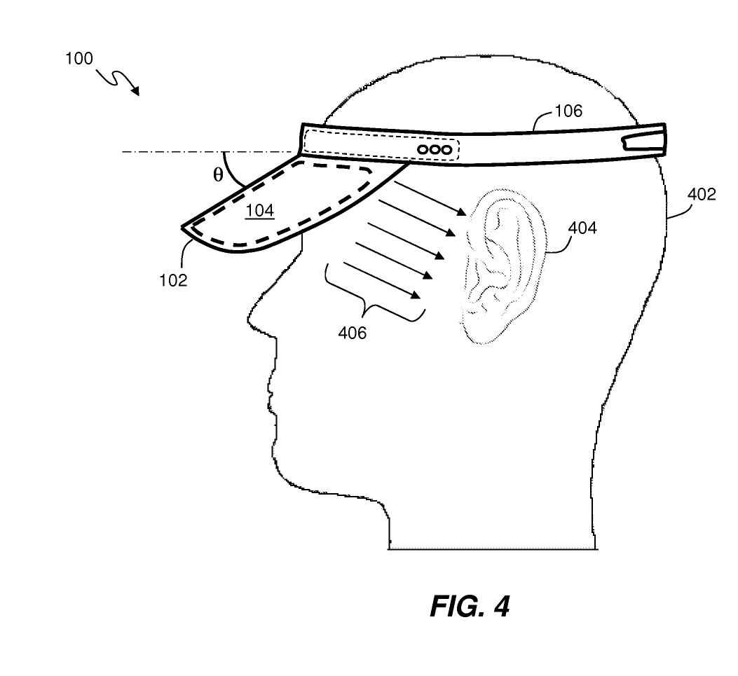

Turning now to FIG. 4, an example embodiment of a head-wearable personal sound speaker system 100 is depicted worn on an example human head 402. Note that the bill 104 is specifically disposed to aim the speaker elements 104 (only one visible) at the ears 404 of the wearer. As indicated by arrows 406, directed sound is aimed at the wearer's ears 404. This is achieved by using, for example, flexible speakers such as those manufactured by Verisonix Corporation of Taipei, Taiwan or the model TLF type speakers manufactured by Yamaha Corporation of Tokyo, Japan. In addition, the angle theta (θ) may be selected such that the speaker elements 104 are properly positioned and aimed.

In some embodiments, a visor or a cap may include a headband with an adjustable strap; a bill attached to the headband and including an flexible fabric sound speaker integrally formed within the bill; an amplifier including a signal input, the amplifier removeably attached to the headband and coupled to the speaker; and a power supply removeably attached to the headband and coupled to the amplifier.

The visor may also include a signal source removeably attached to the headband and coupled to the signal input of the amplifier. The signal source may include a signal receiver. The flexible fabric sound speaker may span the width and length of the bill. The bill may be separable from the headband. The headband may include a removable liner formed from a moisture absorbing and washable material. The headband may be formed from light weight material adapted to allow air to pass through. The adjustable strap may include a mating hook and loop material such as Velcro®. The flexible fabric sound speaker may include a first and a second portion where the first portion is coupled to a first channel of the amplifier and the second portion is coupled to a second channel of the amplifier. The first portion may be disposed on a first side of the bill; the second portion may be disposed on a second side of the bill; and together the first and second portions may be adapted to reproduce stereo sound. The amplifier and the power supply may be contained in a single housing. The housing maybe water tight and include externally accessible waterproof controls adapted to be accessible while the housing is removeably attached to the visor. The externally accessible controls may include a switch operable to activate playback of a predefined music selection. The externally accessible controls may include a switch operable to allow selection of a predefined sound level. The housing may be positioned to not be visible while the visor is worn by a user. The amplifier may be coupled to the speaker via a moisture resistant connection that is not visible while the visor is worn by a user. The signal source may include a signal receiver and a signal transmitter. The visor may also include a microphone removeably attached to the headband and coupled to the transmitter. The signal receiver and transmitter may include a Bluetooth® protocol device and the Bluetooth® protocol device is adapted to use the speaker and the microphone while paired with a wireless phone.

In some embodiments, the visor or a cap may include a headband with an adjustable strap; a bill attached to the headband and including a directional ultrasonic transducer or a directional flexible speaker element integrally formed within the bill; an amplifier attached to the headband and coupled to the ultrasonic transducer or flexible speaker element; and a power supply attached to the headband and coupled to the amplifier.

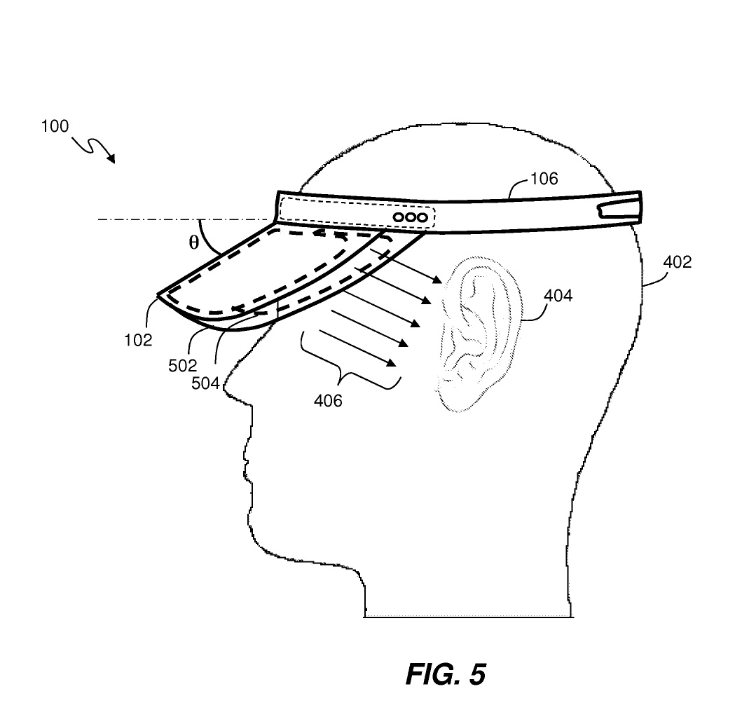

Turning to FIG. 5, a side view of an example head-wearable personal sound speaker system 100 with an extended width bill 502 is shown. In some embodiments, the width of the bill 502 or rim of the visor (or cap) may be extended laterally to allow the curve and shape of the bill 502 to direct sound at the ears 404 of the wearer 402. In other words, the bill 502 maybe made wider than a conventional bill and/or wider than the wearer's head 402. In addition to widening the bill 502, the speaker elements 504 may be widened as well.

In some embodiments, the bill may include waterproof or water resistant material on a top surface that protects the speaker elements from moisture and sunlight. The bill may also or alternatively be coated with a protective material to provide water or light protection.

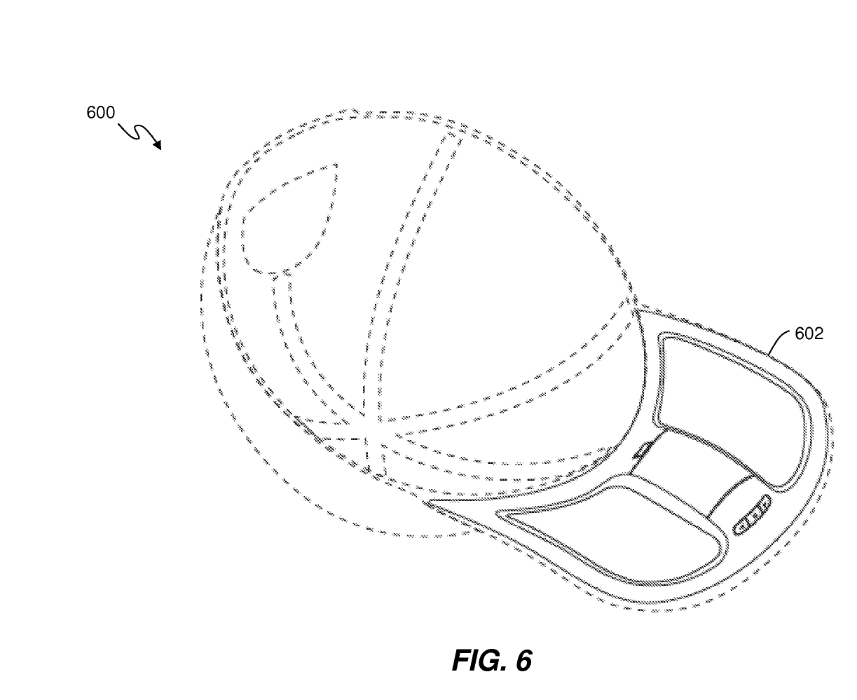

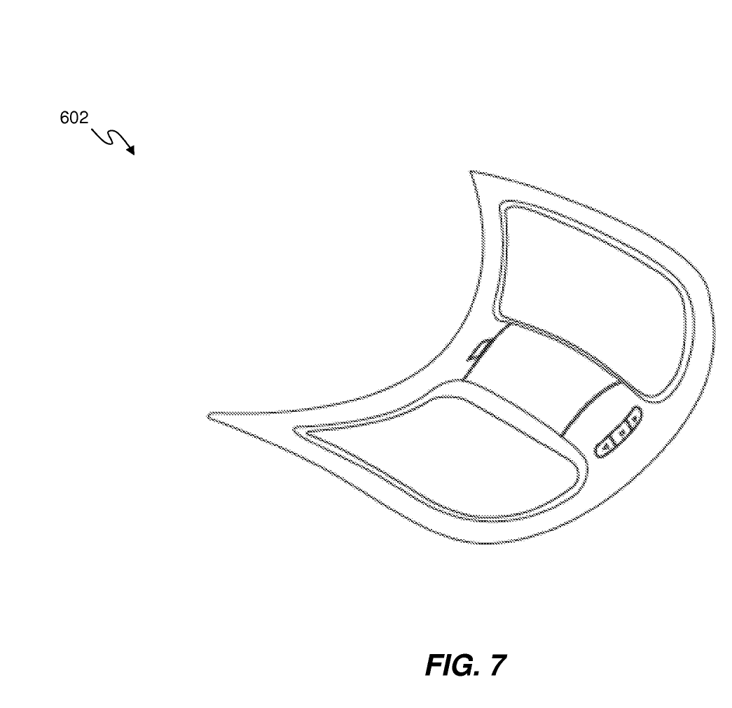

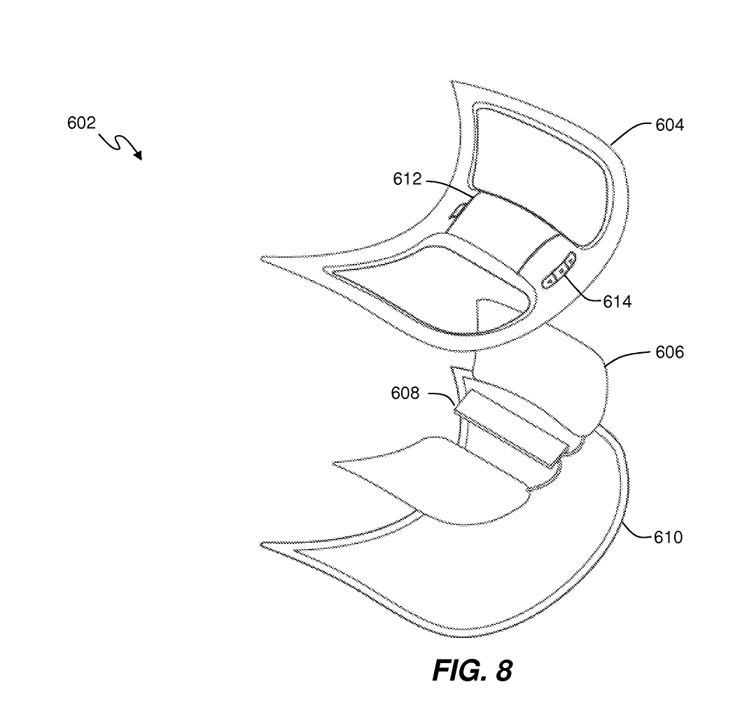

Turning to FIG. 6 an alternative embodiment of a head-wearable personal sound speaker system is shown. The system 600 can include a cap (shown in phantom) or visor with a self-contained sound unit 602 permanently or removeably attached to the bill of the hat. The sound unit 602 may include fasteners to attach to the bill. The sound unit 602 may include a signal source and/or a receiver as described above with respect to other embodiments. FIG. 7 depicts the sound unit 602 without the hat and FIG. 8 depicts an exploded view of the sound unit 602. The invention may be embodied as a self-contained kit that may be added or attached to any suitable hat.

In some embodiments, the sound unit 602 can include a frame 604, speakers 606, electronics 608, and backing 610. The frame 604 can include openings for the speakers 606 and a compartment for the electronics 608, as well as an access door 612 and system control buttons 614 that can be wired (not shown) to the electronics 608.

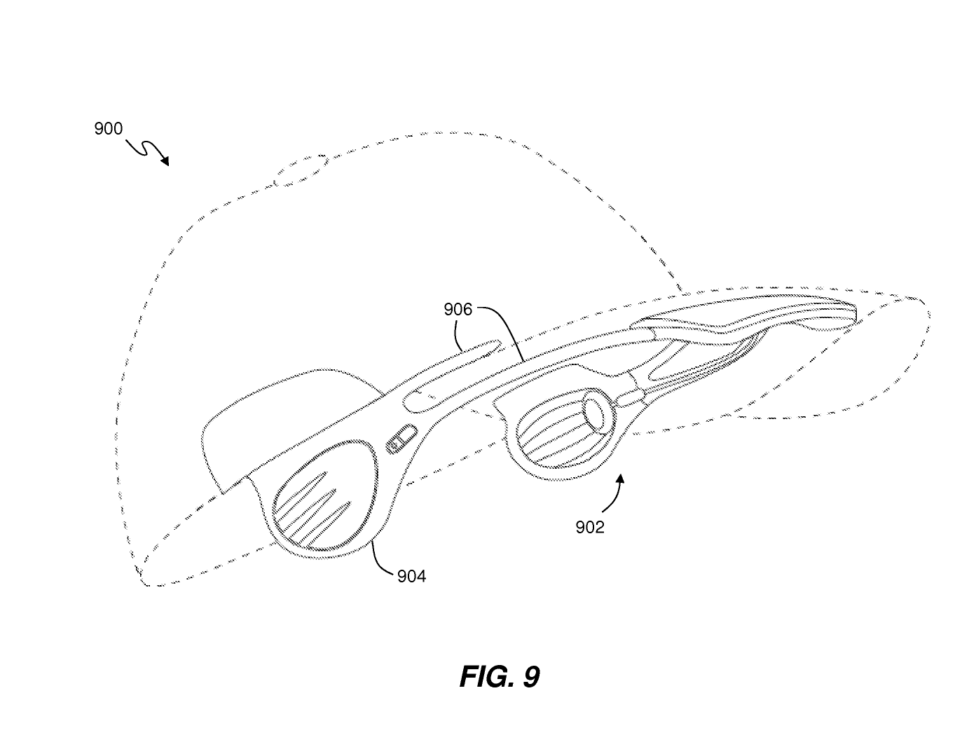

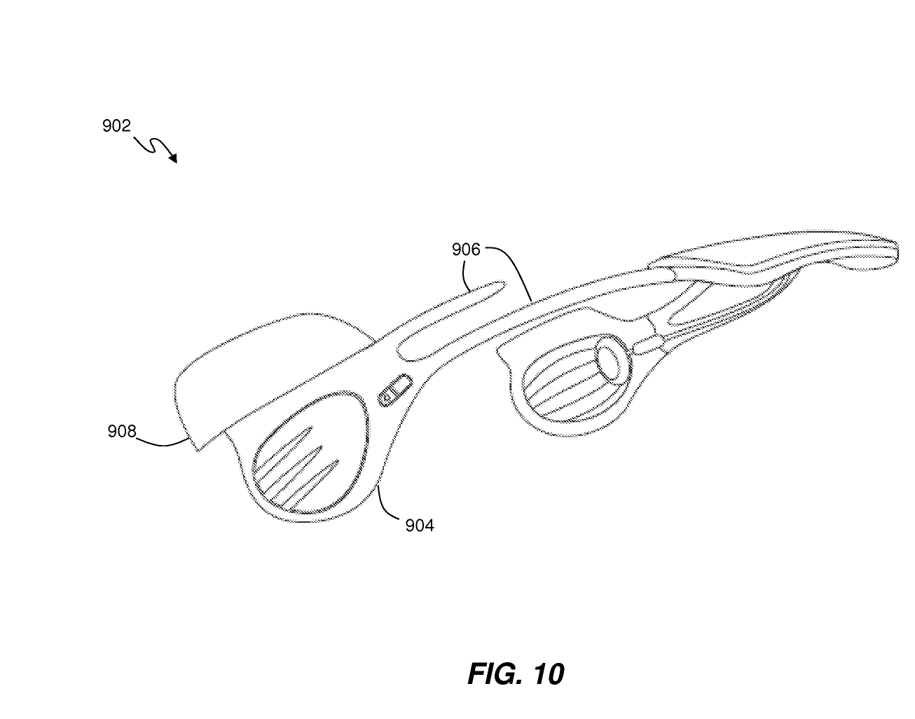

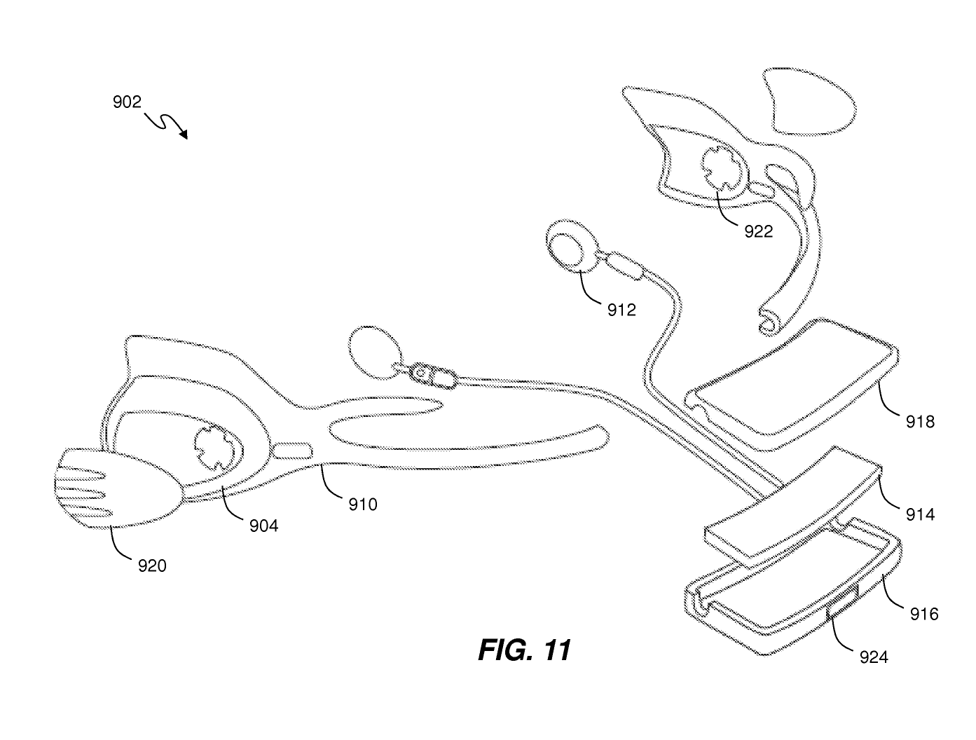

FIG. 9 is a diagram depicting a side perspective view of another alternative example of a head-wearable personal sound speaker system according to embodiments of the present invention. The system 900 can include a cap (shown in phantom) or visor with a self-contained sound unit 902 permanently or removeably attached to the bill and/or sides of the hat. The sound unit 902 may include fasteners to attach to the bill and/or sides of the hat. The fasteners may be embodied as fingers 906 that extend from sound guides 904 and clip or otherwise engage the bill of the hat. The fingers 906 may further include friction fit or snap fit couplings (not shown) to secure the sound unit 902 to the hat. In some embodiments, the sound unit 902 may include speakers, a signal source, and/or a receiver as described above with respect to other embodiments. In some embodiments, the sound unit 902 may only include the sound guides 904 and the fasteners (e.g., fingers 906) for attachment to a hat. In such embodiments, a user may add ear-bud style speakers or other types of speakers to the sound unit 902. FIG. 10 depicts the sound unit 902 without the hat and FIG. 11 depicts an exploded view of the sound unit 902. The invention may be embodied as a self-contained kit that may be added or attached to any suitable hat and/or have a sound system added to it.

In some embodiments, the sound unit 902 can include additional fasteners (e.g., clips 908) for attaching to the inner folds or hem of the hat. In some embodiments, the sound unit 902 can include two wings 910 each including a sound guide 904, speakers 912, electronics 914, electronics compartment 916, and door 918. In some embodiments, the sound guide 904 can include removeable access panels 920. These panels 920 can include fashionable shapes, colors and/or designs including logos or other marks. The panels 920 permit access to the interior of the sound guides 904 to allow a manufacturer or user to more easily install speakers 912 within the sound guides 904. The sound guides 904 may include fasteners 922 (e.g., snap fit or friction fit couplings) that all the speakers 912 to be held securely within the sound guides 904 and to be positioned to optimally aim sound into the sound guides and/or the user's ears. The sound guides 904 may be shaped to provide a passageway that amplifies and/or directs sound from the speakers 912 to the user's ears. The sound guides 904 may further include material to also aid in directing desired frequencies to the user's ears.

In some embodiments, the wings 910 may be permanently or removeably attached to the electronics compartment 916. The electronics compartment 916 may include a control panel 924 for controlling the electronics 914.

Accordingly, while the present invention has been disclosed in connection with the preferred embodiments thereof, it should be understood that other embodiments may fall within the spirit and scope of the invention, as defined by the following claims.

What is claimed is:

1. A visor comprising:
a headband including an adjustable strap;
a bill attached to the headband and including an flexible fabric sound speaker integrally formed within the bill;
an amplifier including a signal input, the amplifier removeably attached to the headband and coupled to the speaker; and
a power supply removeably attached to the headband and coupled to the amplifier.

2. The visor of claim 1 further including a signal source removeably attached to the headband and coupled to the signal input of the amplifier.

3. The visor of claim 2 wherein the signal source includes a signal receiver.

4. The visor of claim 1 wherein the flexible fabric sound speaker spans the width and length of the bill.

5. The visor of claim 1 wherein the bill is separable from the headband.

6. The visor of claim 1 wherein the headband includes a removable liner formed from a moisture absorbing and washable material.

7. The visor of claim 1 wherein the headband is formed from light weight material adapted to allow air to pass through.

8. The visor of claim 1 wherein the adjustable strap includes mating hook and loop material.

9. The visor of claim 1 wherein the flexible fabric sound speaker includes a first and a second portion and wherein the first portion is coupled to a first channel of the amplifier and the second portion is coupled to a second channel of the amplifier.

10. The visor of claim 9 wherein the first portion is disposed on a first side of the bill; the second portion is disposed on a second side of the bill; and together the first and second portions are adapted to reproduce stereo sound.

11. The visor of claim 1 wherein the amplifier and the power supply are contained in a single housing.

12. The visor of claim 11 wherein the housing is water tight and includes externally accessible controls adapted to be accessible while the housing is removeably attached to the visor.

13. The visor of claim 12 wherein the externally accessible controls include a switch operable to activate playback of a predefined music selection.

14. The visor of claim 12 wherein the externally accessible controls include a switch operable to allow selection of a predefined sound level.

15. The visor of claim 11 wherein the housing is not visible while the visor is worn by a user.

16. The visor of claim 1 wherein the amplifier is coupled to the speaker via a moisture resistant connection that is not visible while the visor is worn by a user.

17. The visor of claim 2 wherein the signal source includes a signal receiver and transmitter.

18. The visor of claim 17 further comprising a microphone removeably attached to the headband and coupled to the transmitter.

19. The visor of claim 18 wherein the signal receiver and transmitter includes a Bluetooth protocol device and the Bluetooth protocol device is adapted to use the speaker and the microphone while paired with a wireless phone.

20. A visor comprising:
a headband including an adjustable strap;
a bill attached to the headband and including a directional ultrasonic transducer integrally formed within the bill;
an amplifier attached to the headband and coupled to the ultrasonic transducer; and
a power supply attached to the headband and coupled to the amplifier.
